(19) United States
(12) Patent Application Publication
(10) Pub. No.: US 2015/0019254 A1
(43) Pub. Date: Jan. 15, 2015

(54) Authentication and Access System for Personal Health Information and Methods of Using the Same

(71) Applicants: A. Christopher Ibikunle, Loganville, GA (US); Kathy Day, Monroe, GA (US); Qamar Ul Islam, Elberton, GA (US)

(72) Inventors: A. Christopher Ibikunle, Loganville, GA (US); Kathy Day, Monroe, GA (US); Qamar Ul Islam, Elberton, GA (US)

(21) Appl. No.: 13/940,483

(22) Filed: Jul. 12, 2013

(51) Int. Cl. G06F 21/62; G06F 19/00

(52) U.S. Cl. CPC G06F 21/6245; G06F 19/322
USPC 705/3

(57) ABSTRACT

A system and method for improved authenticated access to personal health information are disclosed. A remote access device sends a request and user registration information to a server when attempting to access the personal health information. If the user is pre-authorized to access the personal health information, access is provided to the personal health information. If the user is not pre-authorized, credential information is requested from the user. If the requested credential information collectively verifies the user is an authentic healthcare provider, the user may be provided permission to access a limited subset of the personal health information in a speedy manner despite not being pre-authorized. A successful attempt to access the personal information may initiate automatic notification of a designated contact (e.g., the patient's relatives) while an unsuccessful attempt may collect further user-related information, and cause automatic notification of the patient or other contact.

### FIELD OF THE DISCLOSURE

The present disclosure relates to systems, apparatus and methods in the field of electronically accessible health information and, more particularly, for an improved authentication and access system for personal health information.

### BACKGROUND

Maintaining health-related information in the form of an electronic medical record, commonly referred to as an “EMR”, is typically done by healthcare providers to document and store information for what used to be maintained in written, hardcopy medical records. Electronic medical records are generally known to be provider-generated and maintained patient health care information and, as such, must comply with regulations that specifies who can access or retrieve a patient's medical records. In the United States, the Health Insurance Portability and Accountability Act (commonly referred to as HIPAA) sets limits on the use and release of medical records maintained by healthcare providers. Essentially, HIPAA protects individually identifiable health information held or transmitted by a covered entity (e.g., a healthcare provider) and commonly refers to such information as “protected health information.”

One skilled in the art will appreciate that a person (generally referred to as a patient) may also personally identify, designate, and/or generate information regarding their own health or the health of a family member, and that such information may be generally considered to be “personal health information.” As such, a patient may designate what may otherwise be protected health information in the hands of a covered entity to be part of their own collective and self-defined personal health information. This aspect helps to place the security decision with regard to personal health information disclosed herein within the control of the patient.

Situations may arise where immediate access is needed to a patient's personal health information. This may be easier for those whom the patient knows and has pre-authorized to have access to their personal health information. But it is much more difficult and time-consuming for those attempting to provide healthcare assistance but who have not been pre-authorized by the patient. For example, a patient's personal health information is not typically easy to access for emergency room personnel or other first responder type of healthcare personnel (e.g., paramedics, firefighters, triage coordinators, and the like) who are normally outside of those whom normally care for the patient. The personal health information for a patient may provide lifesaving information, but getting the information to such healthcare providers in a very timely manner can be problematic. In the absence of an already established relationship between the healthcare provider and the patient, it is often difficult to obtain the necessary health information about the patient when it is an emergency situation. Often, it poses extreme dangers to the patient given time may be of the extreme essence in such cases.

One way to address this issue is for the patient to maintain such personal health information on them in the form of paper or electronic copies. For example, the patient may keep a USB storage device for electronically maintaining relevant personal health information on their person. In case of an emergency, such information may be physically available and accessible to the emergency healthcare personnel in a timely fashion and facilitate easier access to the personal health information for those not pre-authorized or registered to have access to the personal health information. However, requiring a patient to have such personal health information on their physical person is burdensome. Additionally, doing so brings with it the problem of making sure what is on the patient's person is the most current and up-to-date personal health information. Furthermore, security remains an issue with a physical copy of such personal health information with respect to, for example, unfettered access by unauthorized persons.

Another known solution involves requiring the patient to carry an identification card having basic information on critical conditions (e.g., allergies, diabetic medication, etc.) and/or relevant information on whom to contact that may have the necessary personal health information on the patient. In the case of an emergency, a provider may have to contact the entity where the individual's health information is stored and may need to provide further information from the identification card to obtain the necessary information. However, this approach typically suffers from being undesirably time-consuming, especially in an emergency situation, and still suffers from similar security issues and the potential for unfettered access by the card holder.

Thus, there remains a need for an improved way to provide authenticated access to personal health information in a timely manner and with a degree of confidence with respect to whom may have access to such important patient information.

### SUMMARY

In the following description, certain aspects and embodiments will become evident. It should be understood that the aspects and embodiments, in their broadest sense, could be practiced without having one or more features of these aspects and embodiments. It should be understood that these aspects and embodiments are merely exemplary.

One aspect of the disclosure relates to an improved method for authenticated access by a user of a remote access device to personal health information designated by a patient and maintained on a server computing device. The method begins by receiving a request from the remote access device at the server computing device, where the request (such as an emergency access request) is associated with accessing at least a portion of the personal health information. The server receives registration information from the remote access device, where the registration information generally includes information identifying whether the user of the remote access device is pre-authorized to access the personal health information. The server authenticates a first level of access to the personal health information by the user if the registration information indicates the user is pre-authorized to access the personal health information. However, if the registration information indicates the user is not pre-authorized to access the personal health information, then the server receives credential information from the user and, if the requested credential information verifies the user is an authentic healthcare provider, authenticates a limited level of access to the personal health information by the user.

The method may further include tracking any unsuccessful attempt to access the personal health information on the server computing device, and automatically notifying a designated contact with information related to the unsuccessful attempt. This may involve gathering and storing information related one or more of a time of the request, a physical location associated with the remote access device, an image captured from the remote access device, and a network address associated with the remote access device.

Furthermore, the method may also include automatically notifying one or more designated contacts upon providing any level of access to the personal health information in response to the emergency access request. Such notification may be implemented by providing additional information to the one or more designated contacts in response to a successful attempt to access to any of the personal health information after an emergency access request. The additional information may include one or more of an identification of the user of the remote access device, a time related to the successful attempt to access, information identifying a location related to the user of the remote access device, and information identifying what level of access was provided to the user of the remote access device.

In another aspect of the disclosure, another method for authenticated access by a user of a remote access device to personal health information designated by a patient and maintained on a server computing device is disclosed. The method begins by transmitting a request from the remote access device to the server computing device, where the request is associated with accessing at least a portion of the personal health information. If the user of the remote access device is not pre-authorized to access the personal health information, the method then provides credential information by the user of the remote access device to the server computing device. The provided credential information may be automatically gathered from the remote access device, input by the user, or a combination of such. The method concludes by accessing a limited subset of the personal health information on the server computing device if the provided credential information verifies the user of the remote access device is an authentic healthcare provider without requiring the user to be pre-authorized by the patient to access the personal health information.

In yet another aspect of the disclosure, a system is described for providing authenticated access to personal health information by a user of a remote access device through a network. The system generally includes a processing unit and a collection of a volatile memory, a memory storage, and a communication interface that each are respectively coupled to the processing unit. The communication interface provides an operative communication path between the processing unit and the remote access device over the network. The memory storage maintains at least an information management program module, the personal health information designated by a patient, and profile information associated with the personal health information. The profile information identifies which portions of the personal health information may be provided at several differing levels of access, such as a limited level of access and for full access to the personal health information.

The processing unit of the system is operatively configured, when executing the information management program module, to receive a request from the remote access device over the communication path, where the request is associated with accessing at least a portion of the personal health information maintained on the memory storage. The processing unit is also operatively configured, when executing the information management program module, to receive registration information from the user of the remote access device relative to a pre-existing permission to access the personal health information. If the registration information indicates the user of the remote access device does not have pre-existing permission to access the personal health information, the processing unit is then operatively configured to request credential information related to the user of the remote access device from the remote access device. The processing unit is also operatively configured, when executing the information management program module, to access at least one collection of healthcare provider information to verify that the credential information collectively identifies the user as an authentic healthcare provider. Finally, the processing unit is also operatively configured, when executing the information management program module, to provide the limited level of access to the personal health information to the user of the remote access device if the user is identified as an authentic healthcare provider.

Additional advantages of this and other aspects of the disclosed embodiments and examples will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments according to one or more principles of the invention and together with the description, serve to explain one or more principles of the invention. In the drawings,

FIG. 1 is a diagram of an exemplary operating environment for managing personal health information in accordance with an embodiment of the invention;

FIG. 2 is a more detailed diagram of an exemplary server computing device in accordance with an embodiment of the invention;

FIG. 3 is a more detailed diagram of an exemplary access device in accordance with an embodiment of the invention;

FIG. 4 is a diagram of certain exemplary components within the operating environment of FIG. 1 used when initially creating or updating exemplary personal health information in accordance with an embodiment of the invention;

FIG. 5 is a diagram of certain exemplary components within the operating environment of FIG. 1 used when authenticating access to exemplary personal health information in accordance with an embodiment of the invention;

FIG. 6 is a flowchart diagram illustrating exemplary steps of a method for providing authenticated access to personal health information in accordance with an embodiment of the invention from the perspective of operations of a server computing device; and

FIG. 7 is another flowchart diagram illustrating exemplary steps of a method for providing authenticated access to personal health information in accordance with an embodiment of the invention from the perspective of operations of a remote access device.

### DESCRIPTION OF THE EMBODIMENTS

Reference will now be made in detail to exemplary embodiments. Wherever possible, the same reference numbers are used in the drawings and the description to refer to the same or like parts.

In general, the following describes various embodiments of systems, apparatus, and methods for providing improved authentication and access to personal health information as set forth herein. One skilled in the art will appreciate that, generally and as further described herein, personal health information is a broad designation for health-related information identified by a particular individual (more generally referred to as a patient herein). The information may be related to the particular individual and may also be designated, generated, or otherwise identified by one authorized to act on behalf of the particular individual (e.g., the patient's parent or designated guardian or other family member). In other words, a person may personally identify, designate, and/or generate information regarding their health or the health of a family member, and such information is generally considered to be personal health information.

Furthermore, those skilled in the art will appreciate that, generally, a device is considered herein as a communication and computing component. Examples of such a device may be a computer, radio, or other processor-based component or appliance of a larger system that requires or desires components to communicate over communication paths, such as wired or wireless networks. Further examples of devices include, but are not limited to, telephones, cell phones, smart phones, computers, laptops, other handheld devices (such as a PDA or tablet), or any other processor-based appliances that request access to personal health information maintained by another device (e.g., a server type of device).

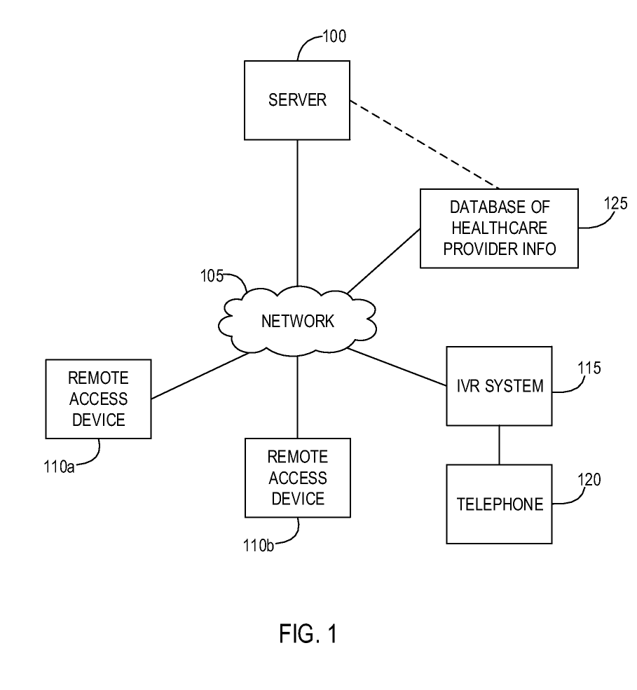

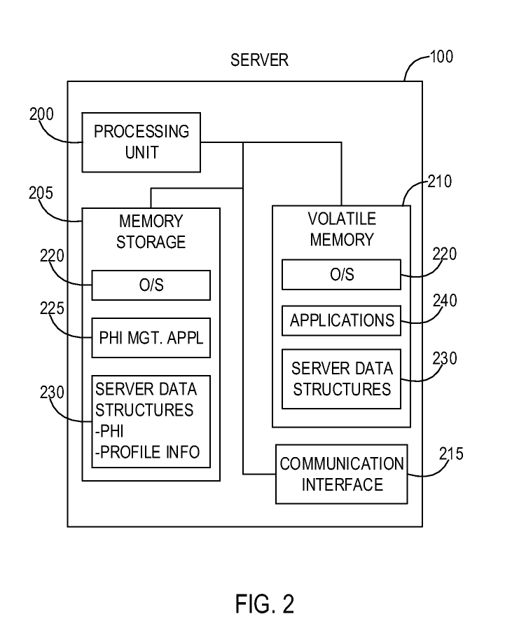

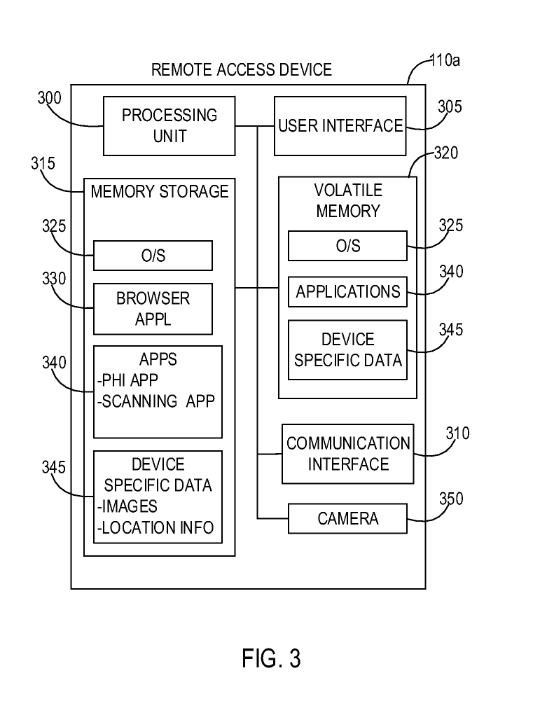

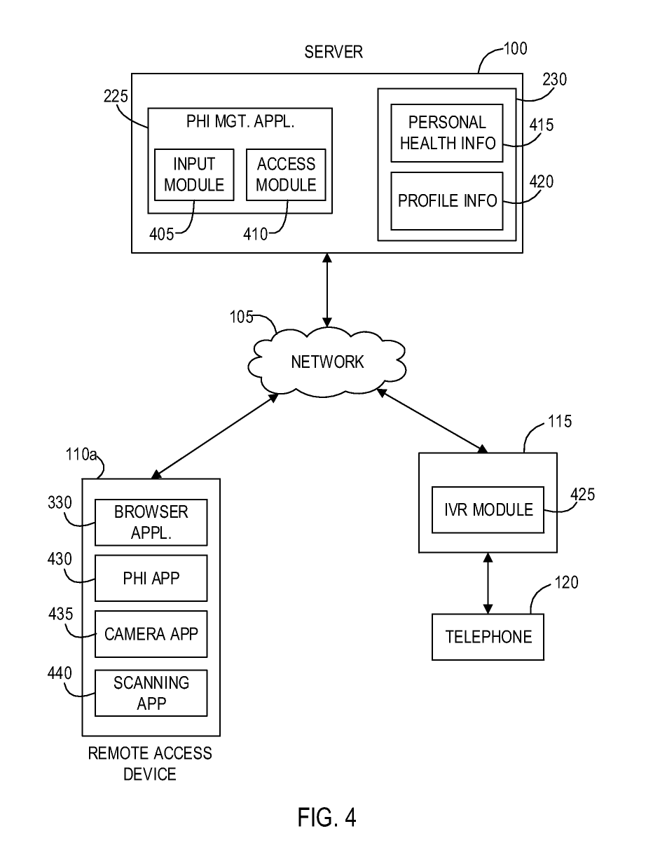

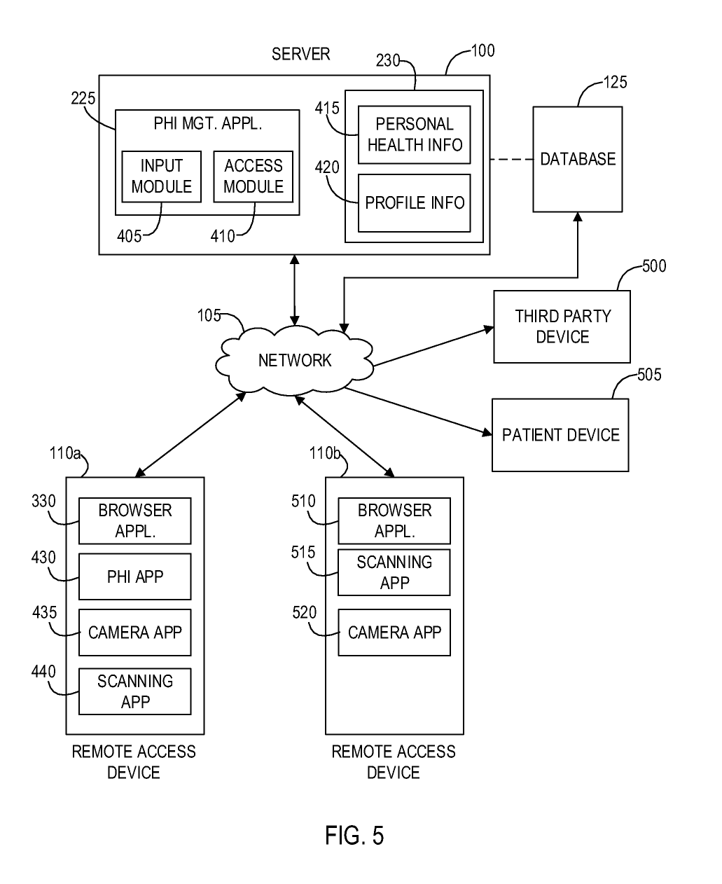

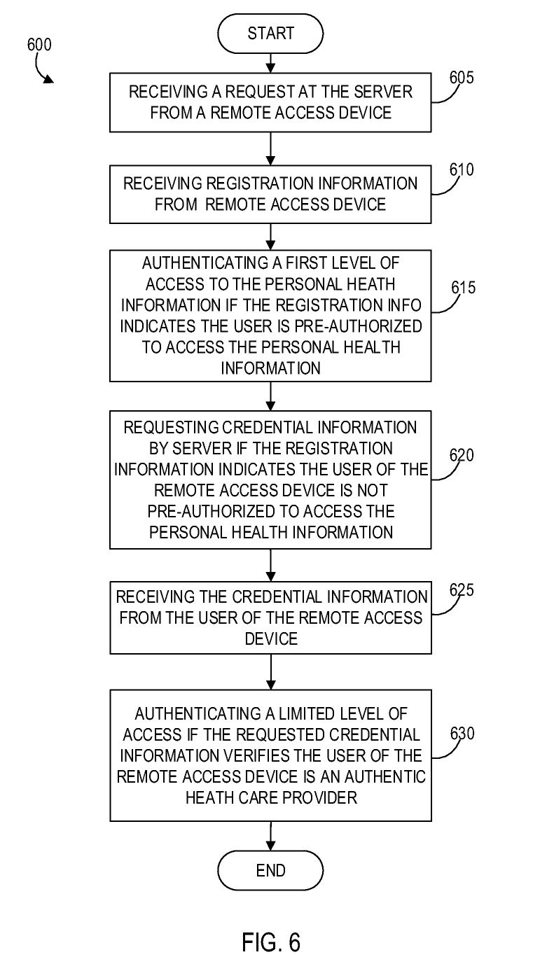

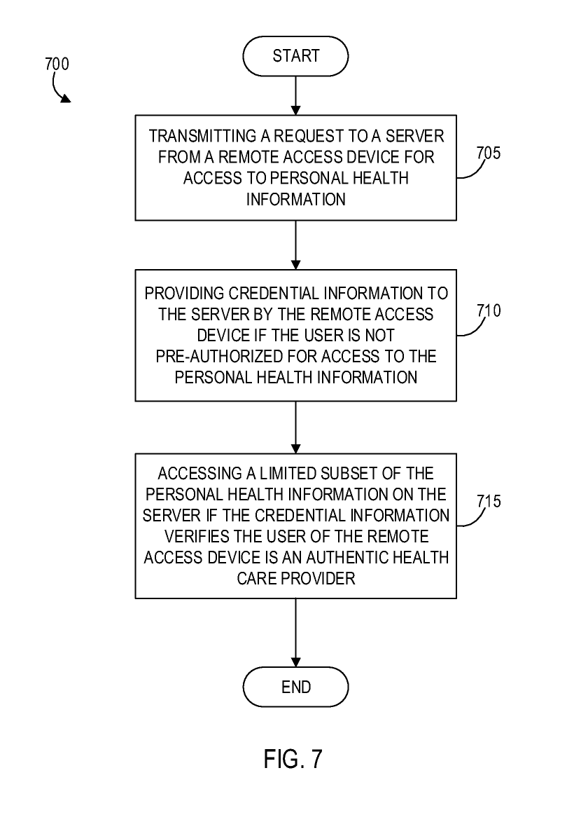

In overview, FIG. 1 provides details on an exemplary operating environment where users may create and update personal health information and systems provide authenticated access to the personal health information. FIGS. 2 and 3 are diagrams providing exemplary hardware and exemplary software details of certain components from FIG. 1. FIGS. 4 and 5 provide details of how exemplary components within FIG. 1 interact as personal health information is created/updated and then later accessed in accordance with embodiments of the invention. FIGS. 6 and 7 are flow diagrams providing algorithmic examples of methods for authenticated access to personal health information.

As noted above, FIG. 1 is a diagram of an exemplary operating environment for managing personal health information in accordance with an embodiment of the invention. Referring now to FIG. 1, the exemplary operating environment includes a variety of components that are operatively coupled. In particular, FIG. 1 illustrates a server computing device 100 that maintains and stores personal health information that may be accessed upon authentication of the user attempting access. Server 100 is shown in communication with network 105, which is also connected to remote access devices 110a/110b, IVR system 115, and a database of healthcare provider information 125. While server 100 is shown connecting through network 105, those skilled in the art will appreciate that server 100 may have a more direct or dedicated connections to other components illustrated in FIG. 1, such as database 125, depending upon implementation details and desired communication paths. Furthermore, those skilled in the art will appreciate that a single database may contain a collection of information in one embodiment, while multiple databases may be used in other embodiments to maintain such a collection of information, such as when attempting to verify credential information supplied by a user and compared with information gathered from one or more databases, such as database 125. Furthermore, database 125 may be implemented with cloud technology that essentially provides networked storage of collections of information.

Network 105 may be a general data communication network involving a variety of communication networks or paths, such as hard wired structures (e.g., LAN, WAN, telecommunication lines, telecommunication support structures and telecommunication processing equipment, etc.), wireless structures (e.g., antennas, receivers, modems, routers, repeaters, etc.) and/or a combination of both depending upon the desired implementation of a network that interconnects server 100 and other components shown in FIG. 1 in an embodiment of the present invention.

Remote access devices 110a, 110b are essentially interactive communication platforms by which a patient user may provide, designate, and update personal health information and a user (e.g., the patient or healthcare provider) may request access to the personal health information. Such devices are generally considered “remote” from the personal health information stored or to be accessed in that such information is not local or otherwise freely available on the device. In various embodiments, remote access devices 110a, 110b, may be implemented using a desktop computer, laptop computer, tablet (such as an Apple iPad® touchscreen tablet), a smartphone (such as an Apple iPhone®) or other such devices capable of communicating over network 105 with server 100. As shown in FIG. 1, remote access device 110a, 110b are coupled and in communication with network 105, but each of them may also be in communication with each other in a more direct manner.

Additionally, FIG. 1 illustrates an interactive voice response (IVR) system 115, which may be connected through network 105 to server 100. IVR system 115 is also in communication with telephone 120. In general, IVR system 115 facilitates taking audio input from telephone 120 to control an interactive session with an information management system on server 100. In one embodiment, IVR system 115 and telephone 120 may be used as one way to generate or update the personal health information associated with the patient in response to verbal prompts. IVR system 115 may take input in the form of telephone keypad tones from telephone 120 and/or audio from the telephone 120 and provide that to the information management system on server 120, which can parse the relevant information provided into parts of the personal health information. Changes or updates to personal health information may be made by the patient or another pre-authorized person with registered access to the information management system managing the personal health information using the IVR features (in addition to a direct update path to provide changes/updates in digital form via one of the access devices 110a, 110b).

FIGS. 2 and 3 are more detailed diagrams of exemplary server computing device 100 and access devices 110a, 110b, respectively, in accordance with an embodiment of the invention. Referring now to FIG. 2, exemplary server 100 is illustrated in a more detailed embodiment with several operatively coupled components comprising a processing unit 200, a communication interface/network interface 215, memory storage 205 and volatile memory 210. Those skilled in the art will appreciate that exemplary server 100 is a hardware-based component that may be implemented with a single processor or may be implemented as a multi-processor component that communicates with devices, such as access devices 110a, 110b. Server 100 may be implemented as a distributed server or server farm that logically allows multiple distinct components to function as one server computing device from the perspective of a client device (e.g., devices 110a, 110b). Likewise, while the embodiment shown in FIG. 2 illustrates a single memory storage 205, exemplary server computing device 100 may deploy more than one memory storage media and do so in differing forms (e.g., conventional hard disk drives, solid state memory such as flash memory, optical drives, RAID systems, cloud storage configured memory, network storage appliances, etc.).

In general, the processing unit 200 of the server 100 performs basic and complex computations and executes operational and application program code and other program modules within the server 100. While not shown in the illustrated embodiment, server 100 may include a directly connected or indirectly connected user interface, such as an input device (e.g., keyboard, mouse, tablet) and a display unit. The display unit may be a screen connected directly to the server via a dedicated graphics interface and bus (not shown) or may be a remote terminal. Communication interface/network interface 215 is coupled to the processing unit 200 and may include other hardware (not shown) for operatively coupling the server 100 to particular devices and networks.

Processing unit 200 is coupled to volatile memory 210 and memory storage 205. Both memory components associated with server 100 provide elements used by the processing unit 200 when creating/updating personal health information and when providing authenticated access to the personal health information according to an embodiment. In the embodiment shown in FIG. 2, memory storage 205 maintains a variety of program code (e.g., operating system 220, personal health information (PHI) management application 225) and other server created data structures (e.g., stored personal health information for a particular patient and profile information associated with a patient's personal health information). Thus, memory storage 205 is a type of computer readable medium on which information (e.g., executable code/modules, data structures, etc.) may be kept in a non-volatile and non-transient manner.

Volatile memory 210 is typically a RAM structure used by processing unit 200 during operation of the server. In the embodiment of FIG. 2, volatile memory 210 is typically populated after boot-up of the server 100 with an instance of operating system 220, various applications 240 (such as the PHI information management application 225), and data and other server created data structures 230. During operation of exemplary server 100, PHI information management application 225 generally operates to receive information that defines or updates the personal health information (including the profile information) and process requests to access the personal health information. In one embodiment, PHI information management application 225 may implement this general functionality with an input module and an access module as described in more detail below. However, other embodiments may implement PHI information management application 225 as a group of other programs, modules or other executable code, each of which being operative to implement one or more features of PHI information management application 225 as described herein that helps create/update the personal health information (including profile information) and provides authenticated and rapid access to the personal health information for registered users and, to a lesser degree, to users that are not pre-authorized or registered but can be verified as actual healthcare providers. As such, those skilled in the art will appreciate that other embodiments may implement receiving and processing personal health information, updating such information, processing requests for such information, and authenticating such requests with a single module or with multiple software code sections and with different programming languages (e.g., PHP server-side scripting language, ASP.NET, Java, ColdFusion, Perl, and Python) designed to operate on the hardware environment of server 100.

Those skilled in the art will appreciate that similar functionality in server 100 may be implemented in other types of hardware. For example, server 100 may be implemented with specially optimized hardware (e.g., a particular application specific integrated circuit (ASIC) having the same functionality as application 225), discrete logic, or a combination of hardware and firmware depending upon requirements of the server, such as power, processing speed, number of processors, number of memory storage units coupled to the processor(s), cost, space, etc.

FIG. 3 is a more detailed diagram illustrating exemplary hardware and software components within an exemplary remote access device (e.g., device 110a) used to connect to server 100 and request access to personal health information. As noted above with regard to FIG. 1, those skilled in the art will appreciate that a remote access device may be implemented by a variety of hardware with functionality that may be hardwired as part of the device or be programmed with code that establishes a desired and advantageous functionality or feature. Referring now to FIG. 3, exemplary remote access device 110a is shown in more detail as several coupled components comprising a processing unit 300, a user interface 305, communication interface/network interface 310, memory storage 315 and volatile memory 320. As with processing unit 200 in server 100, one skilled in the art will appreciate that processing unit 300 generally performs basic and complex computations and executes operational and application program code and other program modules (e.g., apps) within the device 110a.

User interface 305, coupled to the processing unit 300, allows a user of the device to interact with the device. For example, user interface 305 may allow a user of the device to enter information, such as information a patient designates to be part of their personal health information, or designate what part of their personal health information will be made accessible to those with a limited level of access. In one embodiment, user interface 305 may be a simple audio input and audio output. In another embodiment, user interface 305 may be implemented as conventional laptop keyboard and display, while still another embodiment may implement user interface 305 as a smartphone touchscreen having softkeys displayed on the touchscreen that respond to tactile input from the user as well as dedicated hard keys on the exterior of the smartphone device. Those skilled in the art will appreciate the implementation of user interface 305 may vary depending upon the type of device used to implement a remote access device.

Communication interface/network interface 310 is coupled to the processing unit 300 and may include other hardware (not shown) for operatively coupling the device to a specific communication path, such as a transmitter and antenna for coupling device 110a to a wireless communication path or a LAN/Ethernet interface card for coupling device 110a to a wired local area network, such as network 105 of FIG. 1. In one embodiment, communication interface 310 may further include hardware that supports providing location functionality for the remote access device (e.g., location-based functionality based upon gathered real-time data from Wi-Fi or cellular systems). In other embodiments, remote access devices may have location functionality using additional dedicated positioning chips and/or sensors (e.g., Global Positioning System, Galileo, GNSS, or other satellite or radio-based positioning systems).

In an embodiment, a remote access device (such as device 110a) may also include a camera (not shown) for gathering image information. The camera may be used in concert with a camera app or other software module that facilitates gathering image data using the camera hardware. For example, the user of the remote access device may use the camera in the device to take a picture of a patient's prescription information and use that picture as part of what may be provided as personal health information for the patient. In another example, the user of the remote access device may not have permission to access the personal health information and, after one or more unsuccessful attempts to gain such access, the server may cause the remote access device's camera to capture an image of the user attempting such access and send the image back to the server.

Volatile memory 320 and memory storage 315 are each coupled to the processing unit 300 as well. Both memory components provide elements used by processing unit for maintaining and storing information and data used when securely communicating with other devices. In the embodiment shown in FIG. 3, memory storage 315 maintains a variety of program code (e.g., operating system 325, browser application 330, other apps 340 (such as a scanning app that makes use of the device's camera or a dedicated personal health information access app) and other data (e.g., device specific data 345, which may include a images, location information, or other information to be provided when creating/updating the personal health information). Memory storage 315 is a computer readable medium on which information (e.g., executable code/modules, user data, stored messages, etc.) may be kept in a non-volatile and non-transitory manner. Examples of such memory storage 215 may include a hard disk drive, ROM, flash memory or other media structure that allows longer term storage of information. In contrast, volatile memory 320 is typically a random access memory (RAM) structure used by processing unit 300 during operation of the device. In the embodiment of FIG. 3, volatile memory 320 is populated after boot-up of the device 110a with an instance of operating system 325, various applications (such as browser application 330 or other apps 340), and specific program modules that help facilitate providing authenticated access to personal health information (e.g., a dedicated personal health information access app). And during operation of remote access device 110a, volatile memory 320 may also include certain device specific data 345 generated as the device executes instructions as programmed or loaded from memory storage 315.

During relevant operation of device 110a shown in FIG. 3, browser application 230 may operate as a software application that allows the user to easily communicate with the PHI information management application 225 in order to create/update the personal health information and profile information maintained on server 100. Additionally, the dedicated personal health information access app used on remote access device 110a may provide the user of the device with quick access to the personal health information in an advantageously timely manner for those registered or pre-authorized to have access to the personalized health information and for those who are determined to be actual health care providers that attempt to access the information in emergency situations without being pre-authorized or registered users.

As with other embodiments, one skilled in the art will appreciate that similar functionality in remote access devices, such as devices 110a/110b, may be implemented in other types of hardware. For example, device 110a may be implemented with specially optimized hardware (e.g., a particular application specific integrated circuit (ASIC) having the same functionality as application 330 or apps 340), discrete logic, or a combination of hardware and firmware depending upon requirements of the remote access device, such as power, processing speed, number of processors, number of memory storage units coupled to the processor(s), cost, space, etc.

Given this general description of exemplary hardware and software, FIG. 4 is a diagram of certain exemplary components within the operating environment of FIG. 1 used when initially creating or updating exemplary personal health information in accordance with an embodiment of the invention. Referring now to FIG. 4, PHI management application 225 is illustrated as further comprising, in one example embodiment, an input module 405 and an access module 410. Input module 405 may be implemented in one or more sections of programming code that facilitate receiving information that creates or updates one or more parts of the personal health information 415 or the profile information 420. Such received information may be input as personal health information from a variety of sources—such as, for example, (1) pre-existing data supplied or copied to the input module 405 (e.g., EMR data provided with permission of the patient), and (2) information originally created by the patient or the patient's authorized representative (e.g., a family member).

In the illustrated embodiment of FIG. 4, there are several different ways of providing such relevant information to the input module 405 when creating or updating one or more parts of the personal health information 415 or profile information 420. In one embodiment, personal health information 415 may be categorized or separated into one or more groups of health-related information. For example, personal health information 415 may include groups of information related to patient allergies, patient medications, patient past surgeries, patient lab results, patient contact information, etc.

In one embodiment, profile information 420 generally describes who is a registered or pre-authorized user and which parts of the personal health information 415 may be accessible at one or more levels of access. For example, profile information 420 may define different levels of access, such as a first level of access and a more limited level of access to different parts of the personal health information 415. In one embodiment, the first level of access may be associated with a pre-authorized user (e.g., the patient, a family member of the patient who has been pre-authorized by the patient, or a healthcare provider that actively provides ongoing care to the patient and who has been pre-authorized by the patient). The limited level of access may be provided to a user of the remote access device who is not a registered user of the PHI management application 225 or otherwise not pre-authorized to access the personal health information 415, but is confirmed to be an authentic healthcare provider. For example, if the otherwise non-authorized user provides credential information, which is analyzed and determined to verify that the user is an authentic healthcare provider (e.g., an emergency medical physician, an emergency medical technician or nurse, a paramedic, or other healthcare provider without prior authorization for access to the personal health information 415), the user is provided with a limited level of access to certain parts of the personal health information 415. This allows the patient or their authorized representative (e.g., family member) to advantageously and actively define what information makes up the available personal health information and to what extent that personal health information is made available, on a limited basis, to a user that is unregistered but verified to be an actual healthcare provider.

While a first level of access and a limited level of access are described in the above example, the first level may be full access to the personal health information. In another embodiment, the first level may be less than full access to all of the personal health information but more than the limited level of access. And those skilled in the art will appreciate that more than two different levels may be defined and associated with different groups of users (e.g., a full access level for the patient and their existing physicians, a second level of access for certain family members that actively provide care for the patient, and a third level of access that is limited for authentic and actual healthcare workers that do not have an existing relationship with the patient or are not existing registered users of the PHI management application 225).

In one embodiment, the relevant information to be added or updated may be provided via direct input from a user interface (not shown) to the server. The person inputting such information may, for example, be an authorized healthcare provider and the server 100 may be part of a facility associated with the authorized healthcare provider. With permission from the patient, such information may be copied from records or databases separate from server 100 but incorporated, in relevant part, into the separately stored personal health information 415 and/or profile information 420 that is locally accessible to server 100.

In another embodiment, such information may be input from a remote access device (e.g., remote access device 110a) connected to server 100 via network 105. A user of the remote access device, such as device 110a or device 110b, may connect with the input module 405 via, for example, PHI app 430 or browser application 330, and provide relevant information (e.g., textual, audio, and image formatted data) to input module 405. In one example, the user may type in the relevant information and transmit it to input module 405 through a browsing application 330 or PHI app 430. In another example, the user may activate a camera in the remote access device with a camera app 435, capture an image with relevant data to the patient's health (e.g., an image of a current prescription and/or a barcode associated with that prescription), and transmit the image to input module 405. In yet another example, the user may activate a scanning app 440, scan a barcode type of icon (e.g., a linear or matrix (2D) barcode icon), link to information associated with the scanned barcode, and provide some or all of the linked information to input module 405.

Those skilled in the art will appreciate that similar mechanisms and methods may be used to update information that pre-exists in personal health information 415 and profile information 420. For example, a family member of the patient may use a remote access device, such as device 110a, to update prescription information already reflected in the personal health information 415 by altering the dosage to a newer prescribed amount (via text, audio or image data input).

In addition to using a direct input approach with the server's user interface or using a remote access device, as described above, an embodiment may also use the IVR system 115 and telephone 120 to provide information to input module 405. In such an embodiment, a user may use telephone 120 and call a designated number associated with IVR system 115. In response, IVR system 115 may prompt the user for relevant information, such as a user login, an identification of the particular patient, the type or category of information to be provided (e.g., prescription medication information), and the actual information to be provided to input module 405 (e.g., medication type and prescribed dosage amount). Those skilled in the art will appreciate that an IVR module 425 within IVR system 115 may record the audio response from the user's telephone input and/or parse out audio from such input so that the provided telephone input from the user may be analyzed, categorized, and provided to input module 405 in a meaningful manner. In one embodiment, audio clips are captured and provided as information to input module 405. In another embodiment, the audio input may be transcribed and, in some cases, further analyzed relative to categories of personal health information or sent back to the user in a textual format so the user may review and revise the information before sending it along to the input module 415 of PHI management application 225.

While IVR system 115 and IVR module 425 are illustrated as separate hardware and software systems from server 100 in one embodiment, those skilled in the art will appreciate that in another embodiment, server 100 may be programmed to include the same functionality and IVR features offered by those structures. For example, PHI management application 225 may be implemented to internally include an IVR module and be capable of handling calls directly from telephone 120 directly rather than require a separate IVR system 115 and connection through network 105.

In one embodiment, once the personal health information 415 is created for a patient and profile information 420 for the patient is established, PHI management application may generate a barcode type of icon for use when attempting to access the patient's personal health information. The generated barcode or otherwise scannable and electronically recognizable icon may be placed in a variety of conspicuous locations associated with the patient, including but not limited to on clothing, on a card, on a bracelet, on medical equipment used by the patient (e.g., a walker, cane, oxygen equipment), on medication containers used by the patient (e.g., a sticker placed on existing prescriptions), or other items or locations where emergency personnel may find them and have a degree of confidence that they are related to the patient (if not expressly stated with the generated barcode/icon). In one embodiment, such a barcode or icon may be a 2D matrix barcode or, even more specifically, may be a quick response code (commonly known as a QR code). Scanning such a code provide a very quick link to information related to the patient (e.g., name, contact information) and an emergency access request mechanism for access to the patient's personal health information.

FIG. 5 is a diagram of certain exemplary components within the operating environment of FIG. 1 used when authenticating access to exemplary personal health information in accordance with an embodiment of the invention. Referring now to FIG. 5, PHI management application 225 is illustrated as comprising input module 405 and access module 410 running on server 100. Access module 405 is generally code which, when executed on hardware (e.g., processing unit 200), is operative to authenticate access to one or more parts of the personal health information 415 in accordance with the profile information 420 stored in memory 230.

In an embodiment, a user of a remote access device, such as devices 110a or 110b, may desire to access personal health information 415 maintained on server 100. What follows is a general description of the operation of an exemplary system that provides authenticated access to such personal health information. A remote access device, such as device 110a, may be used by someone seeking to access personal health information related to a patient. In one example, the user of the remote access device may avail themselves of the generated barcode/icon mentioned above. With such a barcode/icon, the user may scan the barcode/icon using scanning app 440 to launch a particular landing web page in browser application 330 associated with or provided by the access module 410 of PHI management application 225. In an example where the user may have PHI app 430 loaded on the remote access device, PHI app 430 may be able to scan the barcode and provide similar landing page information within the PHI app 430 itself as the remote access device connects with access module 410.

As part of the landing page, the user may be presented with an option to activate “emergency access” and/or login as a pre-authorized or registered user of PHI management application 225. For example, the landing web page in browser application 330 may include an “emergency access” selection box or other hyperlink that generates and transmits a request associated with accessing at least a portion of the patient's personal health information. The landing web page may provide user login and password fields to be filled in by the user attempting to request access to the personal health information 415. Such login and password information is a type of registration information. Selecting “emergency access” without providing login information may also be considered registration information that indicates the user is not a registered user or otherwise pre-authorized to access the personal health information 415. Additionally, the landing web page may include a check box or other specific user selection that functions as registration information to indicate the user is not a registered user or otherwise pre-authorized to access the personal health information 415.

If the user's registration information indicates the user of the remote access device is registered with the PHI management application 225 in accordance with the patient's profile information 420, then PHI management application 225 authenticates the user is pre-authorized to access the personal health information 415 for the patient and provides a first level of access to the personal health information 415 according to the profile information 420. In one embodiment, the first level of access may be full access to all of the personal health information. However, if the registration information indicates the user is not pre-authorized to access the personal health information 415 for the patient, access module 410 may request credential information related to the user of the remote access device from the remote access device.

Generally, the credential information helps to support a determination that the user attempting access is an actual healthcare provider, despite not being pre-authorized or registered. In this way, rapid emergency access to at least part of the patient's personal health information 415 may be authenticated and advantageously provided without unnecessary delay. The credential information may include one or more parts or types of information, such as a name of the user, title of the user, a date of birth of the user, a location of the user, license information related to the user, affiliated healthcare facility information associated with the user, an image of the user, and an image of the user's identification card.

In some embodiments, the request itself may include types of credential information such that by merely activating “emergency access”, the request may be generated to include one or more types of credential information. For example, a request for access sent from a remote access device may include, as part of the request, automatically gathered location information, which acts as a type of requested credential information. In other words, those skilled in the art will appreciate that credential information may be provided or sent with other information (e.g., the request for emergency access) in order to provide an even more rapid authenticated access mechanism for personal health information that is extremely useful in emergency situations.

Once the credential information is provided from the user of the remote access device to the access module 410, server 100 is operative, under control of PHI management application 225, to access at least one collection of healthcare provider information to verify that the credential information collectively identifies the user as an authentic healthcare provider. For example, a user may be an emergency room physician that was not previously registered to use PHI management application 225 to access a patient's personal health information 415. When prompted by the system, the physician may provide one or more pieces of credential information, such as the physician's name, an image of the physician's identification card, and medical license number. Using this credential information, server 100 may access one or more collections of healthcare provider information in databases, such as database 125, to determine if the credential information provided is accurate and may be independently verified to collectively identify the user as an actual healthcare provider (e.g., an emergency room physician at the healthcare facility associated with the physician's ID card). Thus, when the user is identified as an authentic healthcare provider, server 100 and access module 410 provide access to the user at a limited access level as defined by profile information 420, rather than the first level of access for those pre-authorized to access such information.

In one embodiment, location-based emergency access to patient personal health information may be emphasized. This is where the non-registered user requests access to the patient personal health information and part of what may be considered “credential information” or part of the “request” may be location information from the user's access device as an example of “a location of the user” type of credential information noted above. In another emergency room example, the emergency room physician (or other ER personnel) may use a smartphone to make the request. Part of the information that may be automatically sent with the request (i.e., without a separate prompt by the app or server providing webpage content associated with PHI management application 225 for the user to provide credential information) may be location data gathered from the smartphone. This location data may, for example, be wireless or cellular location-based information or GPS coordinates from a GPS chip in the smartphone. In other embodiments, networking services may also provide more general location information from an IP address or geolocation associated with remote access device and, for example, used by web servers to determine where web visitors are physically located.

In some embodiments, generalized location (e.g., a city name) may be sufficient as a type of credential information collectively used to verify the user is an actual healthcare provider. For example, a general location may be used as one type of credential information provided and along with other credential information (such as the user's name, associated healthcare facility, and the user's medical license information). The collective credential information, when analyzed, may indicate there is a verifiable healthcare provider having the user's name, affiliated with the identified healthcare facility, and having the provided medical license number, and located in the area associated with the general location information (e.g., in Atlanta, Ga.).

However, in other embodiments, it may be desired for the location information to have more particular resolution to be able to indicate a more specific location, such as being within or substantially near a particular healthcare facility. The server can then use that location information when verifying if the user is an actual healthcare provider, and then provide emergency access to the patient's personal health information.

While location information gathered from a user's remote access device may be automatically sent with the request, the server may still prompt the user for additional location information. Thus, if a user attempts to access a patient's personal health information and the user asserts they are inside a healthcare facility but the automatically provided location information from the user's remote access device contradicts this asserted location, the authenticated access system can refuse authentication, deny access, and conclude the user is not an actual healthcare provider. Furthermore, as described below in more detail, the system may gather and store such automatically provided location information as part of tracking unsuccessful access attempts, and report such gathered information to the patient or a designated contact.

Going back to the emergency room example where the ER physician (or other ER personnel) is not pre-registered or previously authorized to access a patient's personal health information, the ER physician uses a smartphone to attempt to quickly gain access to the personal health information through PHI management application 225. The ER physician, for example, may activate an emergency access request through PHI app 430 on the smartphone (a type of remote access device, such as device 110a). Upon activating the request, PHI app 430 gathers location information from the smartphone related to the current physical location of the smartphone. Such location information may be from cellular location services, GPS coordinates from a dedicated onboard GPS chipset, or data from other positioning systems. The smartphone may send that location information along with the emergency access request to access module 410 over network 105 (e.g., a cellular network coupled to a data network in communication with server 100).

At the server 100, PHI management application 225 may process the location information as part of authenticating a limited level of access that allows the ER physician to have quick access to a subset of the patient's personal health information. For example, application 225 may determine if the location information indicates the remote access device is located substantially near or within a healthcare facility on a map. If so, an embodiment may authenticate that the user is a healthcare provider and quickly provide access to the requested patient personal health information. In other words, the location information automatically provided with the request allows the server 100 to authenticate and provide the ER physician with limited but rapid access without a further delay associated with requiring the user to provide additional credential information.

However, in an example where the location information alone is not sufficiently definite or where a higher degree of confidence is desired to verify the user is an actual healthcare provider, additional credential information may be requested, provided by the user, and then be collectively assessed, compared, and analyzed by server 100 with one or more independent sources (e.g., healthcare provider information in database 125) to verify the user is an actual healthcare provider.

As access module 410 processes requests for access, the server 100, when executing PHI management application 225, may also track aspects of successful and unsuccessful attempts to access the personal health information 415. In one embodiment, the server 100 may be configured to monitor and track any unsuccessful attempt to access the personal health information 415 and automatically notify a designated contact with information related to the unsuccessful attempt. For example, when PHI management application 225 cannot verify the user is an authentic healthcare provider and the registration information indicates the user is not a registered or pre-authorized person for purposes of access, PHI management application 225 may automatically send a message to one or more persons designated in the patient's profile information 420 (e.g., the patient or a family member of the patient). The profile information 420 may identify contact information associated with a patient device 505, such that server 100 sends a message to patient device 505 upon an unsuccessful attempt to access the patient's personal health information. Examples of such a notification may include a text message, email message, phone call, or the like and be in accordance with information stored within the patient's profile information 420.

In other embodiments, PHI management application 225 may cause the remote access device unsuccessfully attempting to access the personal health information 415 to gather additional information, which may be recorded and, in some instances, transmitted to a designated person. Such additional information may include information related to or that may identify the remote access device attempting to access the personal health information, an image of the user of the remote access device attempting to access the personal health information, and location information (such as GPS coordinates) of the remote access device attempting to access the personal health information.

In another embodiment, the server 100 may be configured to monitor and automatically notify one or more designated contacts upon providing a predetermined level of access to any of the personal health information in response to the request. In one embodiment, the predetermined level of access is any level of access, while in other embodiments it is for only the limited level of access (or merely less than full access). For example, if any level of access is authenticated and a user successfully accesses the patient's personal health information 415, PHI management application 225 may automatically send a message to one or more persons designated in the patient's profile information 420 (e.g., a family member of the patient or a physician that normally provides care to the patient). In this example, the profile information 420 may identify contact information associated with a third party device 500 known to be operated by the designated person (e.g., a family member or physician), such that server 100 sends notifies the third party device 505 after a successful attempt to access the patient's personal health information. In this manner, those who may be designated in the profile information 420 may receive timely notice that the patient may have been in an accident, as indicated by a successful access by a healthcare provider not previously registered or not pre-authorized to have such access.

Additionally, when notifying a designated person about such a successful attempt to access the patient's personal health information, an embodiment may provide additional information related to the successful attempt. This additional information may include, for example, one or more of an identification of the user of the remote access device, a time related to the successful attempt to access, information identifying a location related to the user of the remote access device, and information identifying what level of access was provided to the user of the remote access device. Thus, the recipient of such additional information may be made aware of circumstances of a potential emergency involving the patient and in a very timely manner.

FIGS. 6 and 7 are flowcharts illustrating exemplary steps of methods for providing authenticated access to personal health information in accordance with several embodiments of the invention. In general, the flowchart of FIG. 6 illustrates exemplary steps performed by an appropriately configured server computing device, such as server 100, while the flowchart of FIG. 7 illustrates exemplary steps performed by an appropriately configured remote access device, such as device 110a or device 110b.

Referring now to FIG. 6, method 600 begins at step 605 where a server computing device receives a request from the remote access device. The request is associated with accessing at least a portion of the personal health information. In one embodiment, the request may be an emergency access request from the remote access device and indicate an emergency situation involving the patient.

At step 610, the server computing device receives registration information from the remote access device. The registration information comprises information identifying whether the user of the remote access device is pre-authorized to access the personal health information. With the request and registration information, the method 600 continues to step 615 where the server computing device authenticates a first level of access to the personal health information by the user of the remote access device if the registration information indicates the user is pre-authorized to access the personal health information.

However, at step 620, if the registration information indicates the user is not pre-authorized to access the personal health information, the server computing device requests credential information related to the user of the remote access device. At step 625, the server receives the credential information from the remote access device related to the user. In one embodiment, the credential information may include at least one or more from the group comprising a name of the user, the user's date of birth, the user's physical location, license information associated with the user, affiliated healthcare facility information associated with the user, an image of the user, and an image of an identification card for the user (such as an official hospital ID card).

At step 630, the server authenticates a limited level of access to the personal health information for the user of the remote access device if the requested credential information verifies the user of the remote access device is an authentic healthcare provider. In one embodiment, the limited level of access may be defined by the profile information 420 as access to a subset of personal health information 415 where the subset is selectively pre-designated by the patient.

Additionally, method 600 may also include the step of accessing at least one collection of healthcare provider information (e.g., medical license information, hospital personnel information, and other types of verifiable healthcare provider information maintained in one or more databases) when verifying that the credential information received from the remote access device collectively identifies the user as an authentic healthcare provider.

In yet another embodiment, the patient may prioritize which type of credential information is more important and given more weight before a decision is made that most or substantially all of the more important credential information collectively identifies the user as an authentic healthcare provider. For example, the patient may setup credential criteria information as part of the profile information 420, and the credential criteria information may designate a numeric weight of importance to particular types of credential information to be confirmed and verified as accurate. As such, prioritizing whether certain types of credential information are better at sufficiently identifying a potential user as an authentic healthcare provider may reflect a patient's thoughts on what is more important to them when granting a limited level of access to the patient's personal health information in a timely manner.

Method 600 may also include tracking any unsuccessful attempt to access the personal health information on the server computing device, and automatically notifying one or more designated contacts with information related to the unsuccessful attempt. More particularly, such tracking may further include gathering and storing information related to one or more of a time of the request, a physical location associated with the remote access device, an image captured from the remote access device, and a network address associated with the remote access device.

Further still, method 600 may include automatically notifying one or more designated contacts upon providing any level of access to the personal health information in response to the emergency access request. In more detail, such a step may be further accomplished by providing, in response to a successful attempt to access to any of the personal health information in response to the emergency access request, additional information to the one or more designated contacts. The additional information may include one or more of an identification of the user of the remote access device, a time related to the successful attempt to access, information identifying a location related to the user of the remote access device, and information identifying what level of access was provided to the user of the remote access device.

FIG. 7 is another flowchart diagram illustrating exemplary steps of a method for providing authenticated access to personal health information in accordance with an embodiment of the invention from the perspective of operations of a remote access device. Referring now to FIG. 7, method 700 begins at step 705 where the remote access device transmits a request to the server computing device. The request is associated with accessing at least a portion of the personal health information. In one embodiment, the request may be an emergency access request from the remote access device to the server and indicate an emergency situation involving the patient. In one embodiment prior to step 705, method 700 may begin by scanning a predetermined code (such as a QR code) to facilitate quickly transmitting the request to the server computing device when attempting to access the patient's particular personal health information.

At step 710, the remote access device provides credential information by the user of the remote access device to the server computing device if the user of the remote access device is not pre-authorized to access the personal health information. The credential information may include one or more of a name, a date of birth, location, license information, affiliated healthcare facility information, an image of the user, and an image of an identification card.

At step 715, the remote access device accesses a limited subset of the personal health information on the server computing device if the provided credential information verifies the user of the remote access device is an authentic healthcare provider without requiring the user to be pre-authorized by the patient to access the personal health information. More specifically, the remote access device accesses the limited subset of the personal health information only if the provided credential information collectively confirms the user of the remote access device is an authentic healthcare provider without requiring the user to have a pre-existing permission for access to more than the limited subset of the personal health information.

Method 700 may also include gathering additional information related to the user of the remote device and sending to the server computing device when the provided credential information does not verify the user is an authentic healthcare provider. The additional information gathered may help identify the user and/or remote access device operated by the user and may, for example, include one or more of a network address associated with the remote access device, an image captured on the remote access device, and a physical location associated with the remote access device.

At least some portions of exemplary embodiments outlined above may be used in association with portions of other exemplary embodiments. Moreover, at least some of the exemplary embodiments disclosed herein may be used independently from one another and/or in combination with one another and may have applications to devices and methods not disclosed herein.

Those skilled in the art will appreciate that embodiments may provide one or more advantages, and not all embodiments necessarily provide all or more than one particular advantage as set forth here. Those skilled in the art will also appreciate that various modifications and variations can be made to the structures and methodologies described herein. Thus, it should be understood that the invention is not limited to the subject matter discussed in the description. Rather, the present invention is intended to cover modifications and variations.

What is claimed is:

1. An improved method for authenticated access by a user of a remote access device to personal health information designated by a patient and maintained on a server computing device, comprising:
receiving a request from the remote access device at the server computing device, the request associated with accessing at least a portion of the personal health information;
receiving registration information from the remote access device, the registration information comprises information identifying whether the user of the remote access device is pre-authorized to access the personal health information;
authenticating, by the server computing device, a first level of access to the personal health information by a user of the remote access device if the registration information indicates the user of the remote access device is pre-authorized to access the personal health information;
requesting, by the server computing device, credential information related to the user of the remote access device if the registration information indicates the user of the remote access device is not pre-authorized to access the personal health information;
receiving the credential information from the user of the remote access device; and
authenticating, by the server computing device, a limited level of access to the personal health information by the user of the remote access device if the requested credential information verifies the user of the remote access device is an authentic healthcare provider.

2. The improved method of claim 1, wherein the request further comprises an emergency access request from the remote access device.

3. The improved method of claim 1, wherein the limited level of access comprises access to a subset of the personal health information, the subset being selectively pre-designated by the patient.

4. The improved method of claim 1, wherein the credential information comprises at least one or more from the group comprising a name, a date of birth, location, license information, affiliated healthcare facility information, an image of the user, and an image of an identification card.

5. The improved method of claim 4 further comprising the step of accessing at least one collection of healthcare provider information to verify that the received credential information received from the remote access device collectively identifies the user as an authentic healthcare provider.

6. The improved method of claim 1 further comprises tracking any unsuccessful attempt to access the personal health information on the server computing device, and automatically notifying a designated contact with information related to the unsuccessful attempt.

7. The improved method of claim 6, wherein the tracking step further comprises gathering and storing information related to at least one from the group comprising a time of the request, a physical location associated with the remote access device, an image captured from the remote access device, and a network address associated with the remote access device.

8. The improved method of claim 2 further comprises the step of automatically notifying one or more designated contacts upon providing any level of access to the personal health information in response to the emergency access request.

9. The improved method claim 8, wherein the step of automatically notifying comprises providing, in response to a successful attempt to access to any of the personal health information in response to the emergency access request, additional information to the one or more designated contacts, wherein the additional information comprising at least one from the group comprising an identification of the user of the remote access device, a time related to the successful attempt to access, information identifying a location related to the user of the remote access device, and information identifying what level of access was provided to the user of the remote access device.

10. An improved method for authenticated access by a user of a remote access device to personal health information designated by a patient and maintained on a server computing device, comprising:
transmitting a request from the remote access device to the server computing device, the request associated with accessing at least a portion of the personal health information;
if the user of the remote access device is not pre-authorized to access the personal health information, providing credential information by the user of the remote access device to the server computing device; and
accessing a limited subset of the personal health information on the server computing device if the provided credential information verifies the user of the remote access device is an authentic healthcare provider without requiring the user to be pre-authorized by the patient to access the personal health information.

11. The improved method of claim 10, wherein the request further comprises an emergency access request from the remote access device.

12. The improved method of claim 10, wherein the credential information comprises at least one or more from the group comprising a name, a date of birth, location, license information, affiliated healthcare facility information, an image of the user, and an image of an identification card.

13. The improved method of claim 12, wherein the step of accessing further comprises accessing the limited subset of the personal health information if the provided credential information collectively confirms the user of the remote access device is an authentic healthcare provider without requiring the user to have a pre-existing permission for access to more than the limited subset of the personal health information.

14. The improved method of claim 10 further comprising the step of scanning a predetermined code to facilitate transmitting the request to the server computing device when attempting to access the personal health information.

15. The improved method of claim 10 further comprising gathering additional information related to the user of the remote device and sending to the server computing device when the provided credential information does not verify the user of the remote access device is an authentic healthcare provider.

16. The improved method of claim 15, wherein the additional information comprises information related to at least one from a group comprising a network address associated with the remote access device, an image captured on the remote access device, and a physical location associated with the remote access device.

17. An improved system for providing authenticated access to personal health information by a user of a remote access device through a network, comprising:
a processing unit;
a volatile memory coupled to the processing unit;
a communication interface coupled to the processing unit, the communication interface providing an operative communication path between the processing unit and the remote access device over the network;
a memory storage coupled to the processing unit, the memory storage maintaining an information management program module, the personal health information designated by a patient, and profile information associated with the personal health information, wherein the profile information identifies which portions of the personal health information may be provided for a limited level of access and for a greater level of access;
wherein the processing unit is operatively configured, when executing the information management program module, to
receive a request from the remote access device over the communication path, the request associated with accessing at least a portion of the personal health information maintained on the memory storage;
receive registration information from the user of the remote access device relative to a pre-existing permission to access the personal health information;
if the registration information indicates the user of the remote access device does not have pre-existing permission to access the personal health information, request credential information related to the user of the remote access device from the remote access device;
access at least one collection of healthcare provider information to verify that the credential information collectively identifies the user as an authentic healthcare provider; and
provide the limited level of access to the personal health information to the user of the remote access device if the user is identified as an authentic healthcare provider.

18. The system of claim 17, wherein the credential information comprises at least one or more parts from the group comprising a name, title, a date of birth, location, license information, affiliated healthcare facility information, an image of the user, and an image of an identification card.

19. The system of claim 17, wherein the processing unit is further operatively configured, when executing the information management program module, to track any unsuccessful attempt to access the personal health information and automatically notify a designated contact with information related to the unsuccessful attempt.

20. The system of claim 17, wherein the processing unit is further operatively configured, when executing the information management program module, to automatically notify one or more designated contacts upon providing a predetermined level of access to any of the personal health information in response to the request.
